(19) United States
(12) Patent Application Publication
(10) Pub. No.: US 2006/0098955 A1
(43) Pub. Date: May 11, 2006

(54) Controller to be connected to a disc type video recorder via IEEE 1394 serial bus

(75) Inventor: Takeshi Nakada, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/267,215

(22) Filed: Nov. 7, 2005

(30) Foreign Application Priority Data
Nov. 5, 2004 (JP) 2004-321843

(51) Int. Cl. H04N 5/781

(52) U.S. Cl. 386/124; 386/125

(57) ABSTRACT

When a controller connected via IEEE 1394 serial bus to a disk type video recorder is commanded by a user to record each broadcast program in stream data extracted by a demultiplexer onto the recorder, the controller stores, into memory, program information on the program such as program title and start time in EIT in the stream data. The controller make the DTV display a list of program information based on program information read from entry descriptors of the recorder. When the user selects, from the program information in the memory, one program information corresponding to one program information having initial value data in the displayed list, the controller writes the selected program information into an entry descriptor corresponding to the program with the program information having the initial value data. The user can easily identify a program based on the displayed program information.

### BACKGROUND OF THE INVENTION

1. Field of the Invention

The present invention relates to a controller such as a set-top box or a digital television receiver to be connected via an IEEE 1394 serial bus to a disk type video recorder, such as a DVD (Digital Versatile Disc) recorder or a hard disk recorder including so-called AVHDD (Audio/Video Hard Disk Drive), which can be controlled by IEEE (Institute of Electrical & Electronics Engineers) 1394 control commands.

2. Description of the Related Art

In recent years, there has been an increasing demand for a disk type video recorders such as an AVHDD which can be controlled by IEEE 1394 control commands, and which are to be connected to a controller such as a set-top box or a digital television receiver using an IEEE 1394 serial bus cable. Some of the controllers for the disk type video recorder such as a set-top box with a built-in tuner, however, may cause problems in some cases as will be explained below.

A controller such as a set-top box with a built-in tuner connected to a disk type video recorder commands the disk type video recorder, for example, to record a digital television broadcast program of a channel selected by a user when the user commands the disk type video recorder for the recording. The controller then reads program information, such as a program title and a start time, from an EIT (Event Information Table) in the stream data of the broadcast program to be recorded, and writes and stores the program information into an object entry descriptor (hereafter referred to simply as “entry descriptor”) of the disk type video recorder.

However, the controller is unable to write and store the program information into the entry descriptor of the disk type video recorder if the controller attempts to first record the digital television broadcast program received by the built-in tuner onto a video tape in D-VHS (Data-Video Home System) format, and then to dub (record) the thus recorded broadcast program onto a recording medium (e.g. hard disk or DVD) of the disk type video recorder. This is because the video tape in the D-VHS format per se has no recording area for recording the program information (i.e. recording area corresponding to the entry descriptor of the disk type video recorder).

In addition to the above case, the inability of the controller to write (record) the program information also occurs in the case where the controller simply fails to write and store the program information into the entry descriptor of the disk type video recorder. In any case, if the controller is unable to store the program information in the entry descriptor of the disk type video recorder, the controller cannot make a display unit display the program information, which is not stored into the entry descriptor, on a list (program list) of the broadcast programs recorded on the disk type video recorder when the user commands the controller to make the display unit display the program list. Thus, in such case, it is not possible for the user to identify the broadcast program on the basis of the program information displayed on the program list.

### SUMMARY OF THE INVENTION

An object of the present invention is to provide such a controller to be connected to a disk type video recorder via an IEEE 1394 serial bus that enables a user to easily and securely identify a broadcast program on the basis of program information displayed on a program list in a manner that even if the controller is unable to store program information of a broadcast program in an entry descriptor of the disk type video recorder at the time of recording the broadcast program onto the disk type video recorder, the controller enables easy storing, at a later time, of the program information in the entry descriptor of the disk type video recorder, so that when the user commands the controller to make a display unit display a program list of broadcast programs recorded on the disk type video recorder, the controller can make the display unit display, on the program list, the program information of all the broadcast programs recorded on the disk type video recorder.

According to the present invention, we provide a controller to be connected via an IEEE (Institute of Electrical & Electronics Engineers) 1394 serial bus to a disk type video recorder which can be controlled by IEEE 1394 control commands, the controller comprising: a tuner for receiving a digital television broadcast signal having a frequency corresponding to a channel selected by a user, and for outputting a transport stream containing stream data of a broadcast program of the channel selected by the user; a demultiplexer for extracting, from the transport stream output from the tuner, the stream data of the broadcast program of the channel selected by the user; an operation means used by a user to command and operate the controller itself and the disk type video recorder for various operations including commanding the disk type video recorder to record the broadcast program contained in the stream data extracted by the demultiplexer; a program information storage means for storing program information which is contained in an event information table in the stream data of each broadcast program to be recorded, when the user, using the operation means, commands the disk type video recorder to record the each broadcast program contained in the stream data extracted by the demultiplexer; a descriptor write control means for controlling to write and store the program information of the each broadcast program into an object entry descriptor of the disk type video recorder, when the user, using the operation means, commands the disk type video recorder to record the each broadcast program; a program list-display control means for controlling to display a list of program information of broadcast program(s), recorded on the disk type video recorder, on a display unit provided in the controller itself or in a further device on the IEEE 1394 serial bus in a manner that when the user, using the operation means, commands the controller to make the display unit display the list of the program information, the program list-display control means reads, from the object entry descriptor(s) of the disk type video recorder, the program information of the broadcast program(s) recorded on the disk type video recorder, and displays the list of the program information (such program information being hereafter referred to as “in-list program information”) on the display unit on the basis of the thus read program information; a program information selecting means used by the user to select, from the program information stored in the program information storage means (such program information being hereafter referred to as “in-storage program information”), one in-storage program information corresponding to one in-list program information which is contained in the list of the program information displayed on the display unit and which has initial value data; and a descriptor additional write control means for controlling to write and store the program information selected by the user, using the program information selecting means, into the object entry descriptor corresponding to the broadcast program with the one in-list program information having the initial value data.

According to the controller of the present invention, when the disk type video recorder is commanded by the user to record a broadcast program contained in stream data received by the tuner of the controller, then program information (such as a program title and a start time) of the broadcast program to be recorded is stored into the program information storage means, in which the program information is contained in an event information table (EIT) of the stream data. When the user selects, from the in-storage program information stored in the program information storage means, one in-storage program information corresponding to one in-list program information having initial value data which is contained in the list of the program information displayed on the display unit, then the selected in-storage program information is written and stored into the object entry descriptor which corresponds to the broadcast program with the one in-list program information having the initial value data.

Thus, even if the controller is unable to write and store program information of a broadcast program into an entry descriptor of the disk type video recorder at the time of recording the broadcast program onto the disk type video recorder, the controller enables easy writing and storing, at a later time, of the program information into the entry descriptor of the disk type video recorder. Accordingly, when the user commands the controller to make the display unit display a program list of broadcast programs recorded on the disk type video recorder, the controller can make the display unit display, on the program list, the program information of all the broadcast programs recorded on the disk type video recorder. This enables a user to easily and securely identify a broadcast program on the basis of the program information displayed on the program list.

Preferably, the controller is connected to a D-VHS (Data-Video Home System) video tape recorder via the IEEE 1394 serial bus, wherein the operation means can be used to command the D-VHS video tape recorder to record the broadcast program contained in the stream data extracted by the demultiplexer, and wherein the program information storage means stores program information of each broadcast program to be recorded, the program information being contained in an event information table in the stream data of the each broadcast program to be recorded, when the user, using the operation means, commands the D-VHS video tape recorder to record the each broadcast program contained in the stream data extracted by the demultiplexer, in addition to when the user, using the operation means, commands the disk type video recorder to record the each broadcast program.

The controller according to the preferred mode is advantageous, for example, in the case where a digital television broadcast program received by the built-in tuner is first recorded onto a video tape in D-VHS format of the D-VHS video tape recorder, and is then dubbed (recorded) onto a recording medium (such as hard disk or DVD) of the disk type video recorder, and in the case where the controller is unable to acquire program information from the video tape in the D-VHS format at the time of the dubbing. Even in such a case, the controller can easily write and store, and thereby acquire, the program information into an object entry descriptor of the disk type video recorder on the basis of program information of a broadcast program stored in the program information storage means at the time of recording the broadcast program onto the D-VHS video tape recorder.

Further, the controller can be a set-top box. Furthermore, the disk type video recorder can be a hard disk recorder.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that all the drawings are shown for the purpose of illustrating the technical concept of the present invention or embodiments thereof, wherein:

FIG. 1 is a schematic oblique view of a set-top box according to an embodiment of the present invention connected to an AVHDD, a DTV receiver and a D-VHS video tape recorder;

FIG. 2 is a schematic electrical block diagram of the set-top box connected to the AVHDD via an IEEE 1394 serial bus;

FIG. 3 is a program list displaying an example of broadcast programs recorded on the AVHDD for use by a user;

FIG. 4 is a tabular view showing an object list descriptor containing object entry descriptors for storing program information of broadcast programs recorded on the AVHDD;

FIG. 5 is a flow chart performed by the set-top box when the set-top box controls the AVHDD to record a broadcast program contained in stream data output from the set-top box;

FIG. 6 is a flow chart performed by the set-top box when the set-top box controls the DTV to display a program list, in which if an entry descriptor of the AVHDD does not store program information, the set-top box writes and stores the program information into the entry descriptor at a later time; and

FIG. 7 is a program information list displaying an example of program information, for use by a user, based on data of program information stored in the set-top box.

### DESCRIPTION OF THE PREFERRED EMBODIMENTS

Embodiments of the present invention, as best mode for carrying out the invention, will be described hereinafter with reference to the drawings. The present invention relates to a controller to be connected via an IEEE (Institute of Electrical & Electronics Engineers) 1394 serial bus to a disk type video recorder such as a hard disk recorder including so-called AVHDD (Audio/Video Hard Disk Drive). The following embodiments describe examples in which the controller according to the present invention is a set-top box. It is to be understood that the embodiments described herein are not intended as limiting, or encompassing the entire scope of, the invention.

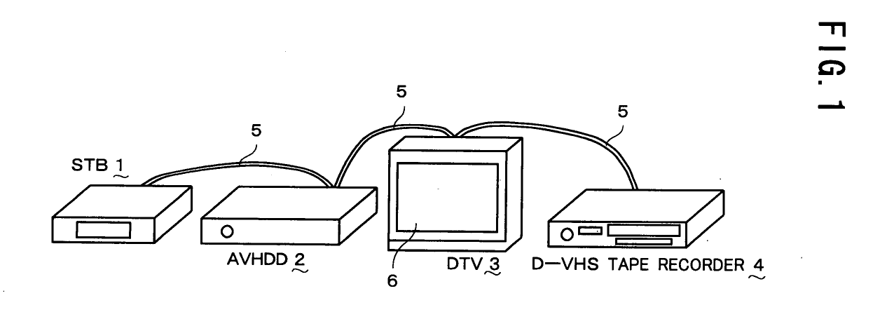

FIG. 1 is a schematic oblique view of a set-top box (hereafter referred to as “STB”) 1 according to an embodiment of the present invention connected to an AVHDD 2, a DTV (Digital Television) receiver 3 (hereafter referred to as “DTV”) and a D-VHS (Data-Video Home System) video tape recorder 4 (hereafter referred to as “D-VHS tape recorder”). From among received broadcast signals, the STB 1 outputs a broadcast signal of a channel selected by a user. The AVHDD 2 is a hard disk recorder of a type that can be controlled exclusively by IEEE 1394 control commands to perform recording and reproduction. The DTV 3 has a monitor 6 (claimed “display unit”) used to display e.g. a list of broadcast programs recorded on the AVHDD 2. Further, IEEE 1394 serial bus cables 5 are used to connect between the STB 1 and the DTV 3, and between the DTV 3 and the AVHDD 2, and also between the AVHDD 2 and the D-VHS tape recorder 4, respectively. In other words, the STB 1, the DTV 3, the AVHDD 2 and the D-VHS tape recorder 4 are connected in daisy chain.

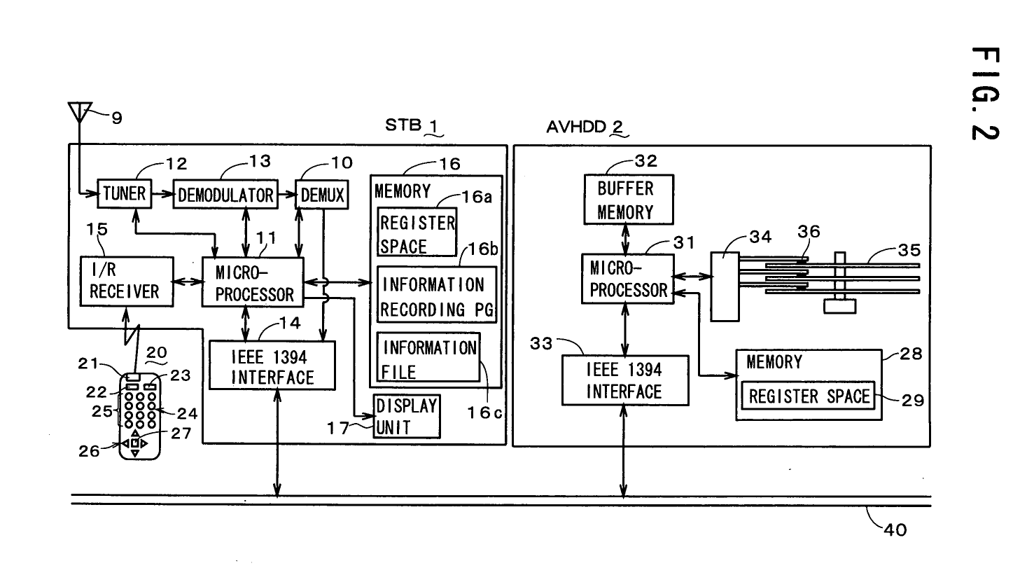

FIG. 2 shows a schematic electrical block diagram of the STB 1 connected to the AVHDD 2 via an IEEE 1394 serial bus 40 (hereafter referred to simply as “bus”). Referring to FIG. 2, the STB 1 comprises: a microprocessor 11 which controls the entire STB 1, and which serves as claimed “descriptor write control means”, “program list-display control means” and “descriptor additional write control means”. The STB 1 further comprises other elements connected to the microprocessor 11 that include a tuner 12, a demodulator 13, a DEMUX (demultiplexer) 10, an IEEE 1394 interface 14 (hereafter referred to simply as “interface”), an infrared signal receiver (I/R receiver) 15, a memory 16 (claimed “program information storage means”) and a display unit 17 (claimed “display unit”). The functions of these elements will be described below.

The tuner 12 receives, via an antenna 9, a digital television broadcast signal having a frequency corresponding to a channel selected by a user, and outputs a transport stream containing stream data of the broadcast program of the channel selected by the user. The demodulator 13 demodulates the transport stream, output from the tuner 12, according to the broadcast system. From the transport stream output from the demodulator 13, the DEMUX 10 extracts stream data of the broadcast program of the channel selected by the user. The interface 14 is an interface circuit for sending and receiving IEEE 1394 control commands and their response signals, and also sending and receiving stream data, to and from an external device such as the AVHDD 2 on the bus 40.

The infrared signal receiver 15 receives a command signal in an infrared signal format sent from a remote control 20, and converts the command signal to, and thereby generates, a normal digital signal, and further sends the thus generated digital signal to the microprocessor 11. The memory 16 stores: a register space 16a for storing various information on its own node (STB 1) and other nodes (e.g. AVHDD 2) on the bus 40; a program information-recording program (information recording PG) 16b which is a program for storing program information in an object entry descriptor (hereafter referred to as “entry descriptor”) of the AVHDD 2 after recording the broadcast program onto the AVHDD 2; a program information file (information file) 16c which is a file for storing program information of the broadcast program to be recorded, when recording the stream data output from the STB 1 itself onto one of the video recorders on the bus 40 (e.g. AVHDD 2 or D-VHS tape recorder 4); and so on. In the present specification, the term “program information” is used to mean a heading of a broadcast program such as a program title and a start time.

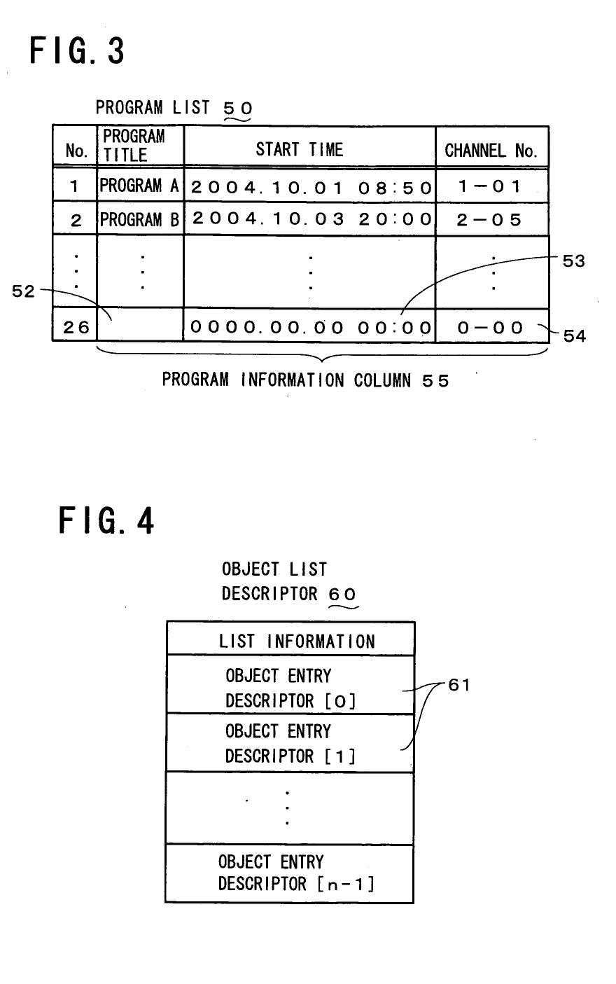

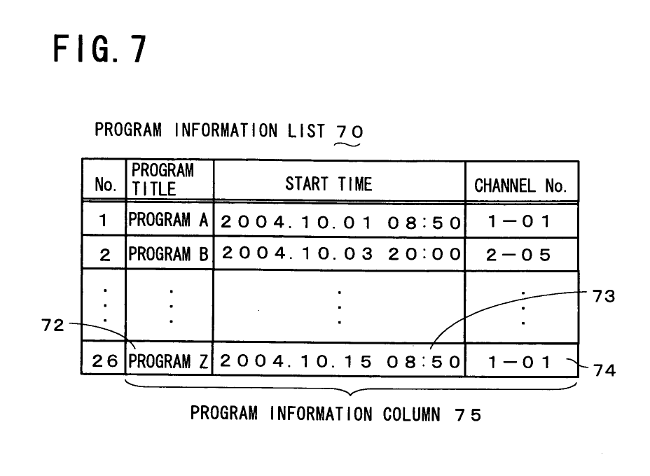

The remote control 20 (claimed “operation means”), which a user uses to command and operate the STB 1, the AVHDD 2 and so on, has an infrared signal sending unit 21 and a key unit 24 having various keys. The keys of the key unit 24 include a power supply key 23, numeric input keys 25, cursor keys 26, a decision key 27, and additionally, a menu key 22 to command the microprocessor 11 to display various menus on the monitor 6 of the the DTV 3 or the display unit 17. The keys on the remote control 20 are used e.g. for command and operation such as displaying a list (program list) of broadcast programs, recorded on the AVHDD 2, on the monitor 6 of the DTV 3 or on the display unit 17 of the STB 1 itself, and such as recording a broadcast program contained in stream data output from the STB 1 itself onto the AVHDD 2. Note that the combination of the remote control 20 with a later described program list 50 (refer to FIG. 3) and a later described program information list 70 (refer to FIG. 7) corresponds to claimed “program information selecting means”.

On the other hand, the AVHDD 2 comprises: a microprocessor 31 for controlling the entire AVHDD 2; a memory 28 for storing e.g. a register space 29 which is to store various information on its own node (AVHDD 2) and other nodes (e.g. STB 1) on the bus 40; and an IEEE 1394 interface 33 (hereafter referred to simply as “interface”) for receiving data, such as control commands and stream data, from e.g. the STB 1 via the bus 40. The AVHDD 2 further comprises: multiple hard disks 35 which are recording media; multiple magnetic heads 36 for writing and reading data to and from the hard disks 35; a head drive unit 34 for driving the magnetic heads 36; and a buffer memory 32 for temporarily storing the data to be recorded or storing the read data.

Referring now to FIG. 3, the following explains a problem generally occurring when the STB 1 is unable to store program information in the entry descriptor of the AVHDD 2 at the time of recording a broadcast program(s) onto the AVHDD 2. As already described in the Background of the Invention, the STB 1 is unable to store program information in the entry descriptor of the AVHDD 2 if the STB 1 attempts to first record a broadcast program, contained in stream data received by the STB 1, onto a video tape of the D-VHS tape recorder 4, and then to dub the thus recorded broadcast program onto a hard disk 35 of the AVHDD 2, or if the STB 1 simply fails to write and store the program information of the recorded broadcast program into the entry descriptor of the AVHDD 2 at the time of recording the broadcast program onto the AVHDD 2.

In such a case, when a user, using the remote control 20, commands display of a program list of broadcast programs recorded on the hard disks 35 of the AVHDD 2, it may occur that as shown by a program list 50 of FIG. 3 with a program information column 55 consisting of a program title column 52, a start time column 53 and a channel number column 54, there is program information (e.g. as designated by reference numeral 26 in FIG. 3) which remains to have initial value data in the program information column 55. In this case, the user cannot properly identify the broadcast program based on the information in the program information column 55 of the program list 50.

FIG. 4 is a tabular view showing an object list descriptor 60 containing the above object entry descriptors or simply entry descriptors 61. Each of the entry descriptors 61 forming the object list descriptor 60 stores program information of each broadcast program recorded on the AVHDD 2. Based on the program information of the broadcast programs stored in these entry descriptors 61, the microprocessor 11 of the STB 1 displays the program list 50 on the monitor 6 of the DTV 3.

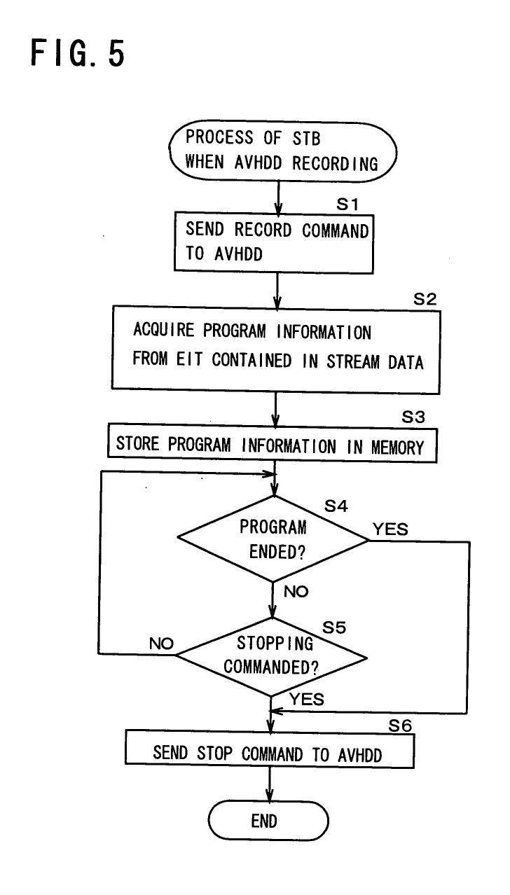

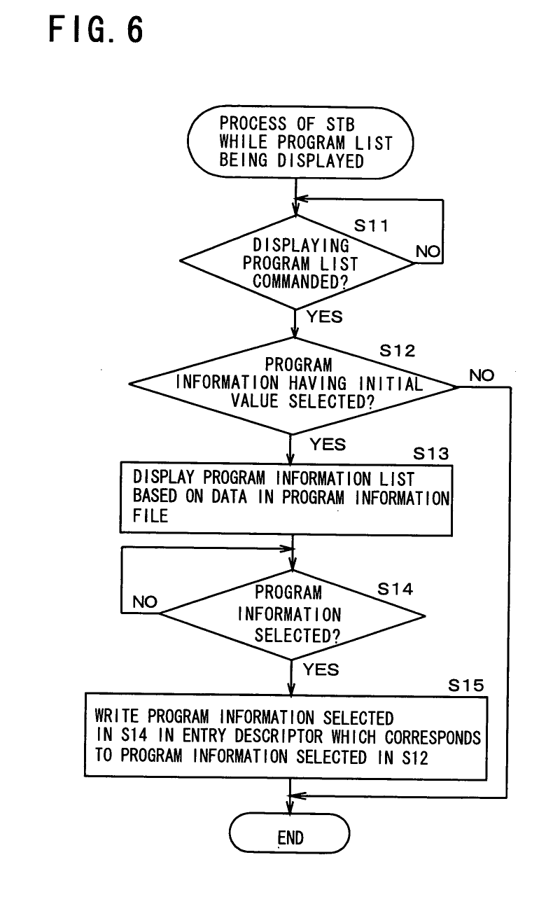

The STB 1 according to the present embodiment performs processes shown in the flow charts of FIG. 5 and FIG. 6, and thereby solves the problem described above with reference to FIG. 3 as caused by the inability of a controller (STB) to store program information in an entry descriptor of a disk type video recorder (AVHDD). Referring to the flow chart of FIG. 5, the following describes a process performed by the STB 1 when the STB 1 controls the AVHDD 2 to record a broadcast program contained in stream data output from the STB 1. When a user, using the remote control 20, commands the microprocessor 11 of the STB 1 to make the AVHDD 2 record a broadcast program contained in stream data output from the STB 1, the microprocessor 1 detects this command of recording, and outputs stream data extracted by the DEMUX 10 to the AVHDD 2, and further sends a record command to the AVHDD 2 (S1).

Next, from an EIT (Event Information Table) [p/f] contained in the stream data while being output to the AVHDD 2, the microprocessor 11 of the STB 1 acquires program information (program title, start time and channel number) of the broadcast program while being recorded (S2). The microprocessor 11 writes and stores the thus acquired program information into an entry descriptor 61 of the AVHDD 2, and at the same time stores the program information in the program information file 16c in the memory 16 (S3). Thereafter, if the broadcast program to be recorded ends (YES in S4), or if the user, using the remote control 20, commands stopping the recording during the recording (YES in S5), the microprocessor 11 sends a stop command to the AVHDD 2 (S6) to end the recording process. By performing the above recording process for each of multiple broadcast programs which the user commands the microprocessor 11 of the STB 1 to record, the program information file 16c in the memory 16 consequently stores multiple program information on the multiple broadcast programs.

Note here that in the case of recording a broadcast program to the D-VHS tape recorder 4, a different process is used. The D-VHS tape recorder 4 has neither entry descriptor nor recording area for recording program information in contrast to the case of the AVHDD 2. Accordingly, when recording a broadcast program contained in stream data output from the STB 1 onto the D-VHS tape recorder 4, the microprocessor 11 of the STB 1 stores, only in the program information file 16c in the memory 16, program information acquired from an EIT [p/f] in the stream data while being output to the D-VHS tape recorder 4, without attempting to record the program information onto the D-VHS tape recorder 4.

Referring now to the flow chart of FIG. 6, the following describes a process performed by the STB 1 when the STB 1 controls the DTV 3 to display a program list, in which if the entry descriptor of the AVHDD 2 does not store program information, the STB 1 writes and stores the program information into the entry descriptor at a later time. When the user, using the remote control 20, commands the microprocessor 11 of the STB 1 to display a program list of broadcast programs recorded on the AVHDD 2 (YES in S11), the microprocessor 11 detects this command, and reads program information on the broadcast programs recorded on the AVHDD 2 from the entry descriptors 61 of the AVHDD 2 via the interface 14, and further displays a program list 50 shown in FIG. 3 on the monitor 6 of the DTV 3 on the basis of the thus read program information.

Thereafter, when the user uses the remote control 20 to select, from the program list 50, program information of a broadcast program (e.g. the program information designated by reference numeral 26 in FIG. 3) the data of which is not shown in the program information column 55 (namely which has or remains to have initial value data in each of the columns 52, 53 and 54 in the program information column 55) (YES in S12), the microprocessor 11 of the STB 1 displays a program information list 70 shown in FIG. 7, for use by a user, on the basis of data of program information stored in the program information file 16c in the memory 16 of the STB 1 (S13), wherein the program information list 70 is provided with a program information column 75 consisting of a program title column 72, a start time column 73 and a channel number column 74. Subsequently, when the user references the information in the program information columns 75, and selects, from the plural program information in the program information list 70, program information of a broadcast program corresponding to the program information selected in the above step S12 (YES in S14), then the microprocessor 11 of the STB 1 writes and stores the program information thus selected in the step S14 into an entry descriptor 61, in the AVHDD 2, which corresponds to the broadcast program having the program information selected in the step S12 (S15).

As described in the foregoing, when a user commands the STB 1 of the present embodiment to control a video recorder(s) on the bus 40, including the AVHDD 2, to record a broadcast program(s) contained in stream data received by the tuner 12 of the STB 1 itself (namely when recording), the STB 1 stores, in advance for later use, program information such as a program title and a start time of the broadcast program(s) each of which is to be recorded, and each of which is contained in an EIT in the received stream data. Thereafter, from a program list 50 displayed on the monitor 6 of the DTV 3, the user selects program information of a broadcast program whose information is not shown in the program information column 55. Subsequently, from the program information stored in advance, the user selects program information of the broadcast program corresponding to the selected program information, whereby the selected program information is written and stored into an entry descriptor 61 of the AVHDD 2.

Thus, even if the STB 1 is unable to store program information of a broadcast program in an entry descriptor 61 of the AVHDD 2 at the time of recording the broadcast program onto the AVHDD 2, the STB 1 enables easy storing, at a later time, of the program information in the entry descriptor 61 of the AVHDD 2. Accordingly, when the user commands the STB 1 to make the DTV 3 display a program list 50 of broadcast programs recorded on the AVHDD 2, the STB 1 can make the DTV 3 display, on a program information column 55 of the program list 50, the program information of all the broadcast programs recorded on the AVHDD 2. This enables a user to easily and securely identify a broadcast program on the basis of program information displayed on the program information column 55 of the broadcast list 50.

It is to be noted that the present invention is not limited to the above-described embodiments, and various modifications are possible. For example, the above embodiment shows the case in which the controller according to the present invention is an STB 1. However, the controller to which the present invention is to be applied is not limited thereto, and can be a device, such as a digital television receiver or a D-VHS video tape recorder, with a built-in tuner for digital television broadcast. Furthermore, the above embodiment shows the case in which an AVHDD is used as a disk type video recorder for recording broadcast programs. However, the disk type video recorder is not limited thereto, and can be a video recorder, such as a DVD recorder, which can be controlled by a command contained in a disc subunit. In addition, program information to be written and stored into an entry descriptor is not limited to program title, start time and channel number, and can include other program information in an EIT.

The present invention has been described above using presently preferred embodiments, but such description should not be interpreted as limiting the present invention. Various modifications will become obvious, evident or apparent to those ordinarily skilled in the art, who have read the description. Accordingly, the appended claims should be interpreted to cover all modifications and alterations which fall within the spirit and scope of the present invention.

This application is based on Japanese patent application 2004-321843 filed Nov. 5, 2004, the contents of which are hereby incorporated by reference.

What is claimed is:

1. A controller to be connected via an IEEE (Institute of Electrical & Electronics Engineers) 1394 serial bus to a disk type video recorder which can be controlled by IEEE 1394 control commands, the controller comprising:
a tuner for receiving a digital television broadcast signal having a frequency corresponding to a channel selected by a user, and for outputting a transport stream containing stream data of a broadcast program of the channel selected by the user;
a demultiplexer for extracting, from the transport stream output from the tuner, the stream data of the broadcast program of the channel selected by the user;
an operation means used by a user to command and operate the controller itself and the disk type video recorder for various operations including commanding the disk type video recorder to record the broadcast program contained in the stream data extracted by the demultiplexer;
a program information storage means for storing program information which is contained in an event information table in the stream data of each broadcast program to be recorded, when the user, using the operation means, commands the disk type video recorder to record the each broadcast program contained in the stream data extracted by the demultiplexer;
a descriptor write control means for controlling to write and store the program information of the each broadcast program into an object entry descriptor of the disk type video recorder, when the user, using the operation means, commands the disk type video recorder to record the each broadcast program;
a program list-display control means for controlling to display a list of program information of broadcast program(s), recorded on the disk type video recorder, on a display unit provided in the controller itself or in a further device on the IEEE 1394 serial bus in a manner that when the user, using the operation means, commands the controller to make the display unit display the list of the program information, the program list-display control means reads, from the object entry descriptor(s) of the disk type video recorder, the program information of the broadcast program(s) recorded on the disk type video recorder, and displays the list of the program information (such program information being hereafter referred to as “in-list program information”) on the display unit on the basis of the thus read program information;
a program information selecting means used by the user to select, from the program information stored in the program information storage means (such program information being hereafter referred to as “in-storage program information”), one in-storage program information corresponding to one in-list program information which is contained in the list of the program information displayed on the display unit and which has initial value data; and
a descriptor additional write control means for controlling to write and store the program information selected by the user, using the program information selecting means, into the object entry descriptor corresponding to the broadcast program with the one in-list program information having the initial value data.

2. The controller according to claim 1,
wherein the controller is connected to a D-VHS (Data-Video Home System) video tape recorder via the IEEE 1394 serial bus,
wherein the operation means can be used to command the D-VHS video tape recorder to record the broadcast program contained in the stream data extracted by the demultiplexer, and
wherein the program information storage means stores program information of each broadcast program to be recorded, the program information being contained in an event information table in the stream data of the each broadcast program to be recorded, when the user, using the operation means, commands the D-VHS video tape recorder to record the each broadcast program contained in the stream data extracted by the demultiplexer, in addition to when the user, using the operation means, commands the disk type video recorder to record the each broadcast program.

3. The controller according to claim 2,
which is a set-top box.

4. The controller according to claim 3,
wherein the disk type video recorder is a hard disk recorder.

5. The controller according to claim 2,
wherein the disk type video recorder is a hard disk recorder.

6. The controller according to claim 1,
which is a set-top box.

7. The controller according to claim 1,
wherein the disk type video recorder is a hard disk recorder.
